(19) United States
(12) Patent Application Publication
(10) Pub. No.: US 2005/0027703 A1
(43) Pub. Date: Feb. 3, 2005

(54) Method of converting data containing characters into corresponding icon on a portable platform

(75) Inventors: Tai Shui Ho, Taipei Hsien (TW); Shih Kuang Tsai, Taipei Hsien (TW); Xiao Feng Mao, Shanghai City (TW)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei Hsien (TW)

(21) Appl. No.: 10/627,926

(22) Filed: Jul. 28, 2003

(51) Int. Cl. G06F 7/00

(52) U.S. Cl. 707/4

(57) ABSTRACT

This invention is to provide a method of converting data containing characters into a corresponding icon on a portable platform, which comprises the steps of receiving data containing characters by the platform, finding a character group from the data containing characters for representing an icon according to a predetermined format, distinguishing the character group from general characters in the data containing characters, finding an icon corresponding to the character group and the general characters, and showing the icon on a display of the platform. By utilizing this invention, a desired icon will appear on a display of the prior portable platform when a corresponding characters being received.

### FIELD OF THE INVENTION

The present invention relates to the conversion of data containing characters into a corresponding icon and more particularly to a method of converting data containing characters into a corresponding icon by a portable platform and showing the same thereon.

### BACKGROUND OF THE INVENTION

Information industry has known a rapid, spectacular development in recent years, leading to the continuous availability of a wide variety of new information products. This really brings a great convenience to human beings. Also, they are closely related to our daily life and work. In response to various kinds of new information products being developed, many people become more critical with respect to features and quality of the information products. Further, for meeting the needs of vast consumers, new features are continuously added in newly available information products by the manufacturers of information product. For example, a typical example of the information products is cellular phone which, as viewed by many people, has become an important communication tool in their daily life. A cellular phone not only can be used for making or receiving a call but also can be used for sending or receiving short messages while communicating with another person. This makes the compact, portable cellular phone as the most important, widely used personal communication tool. It is also understood that the information product market is very competitive. As to the cellular phone market, various brands of cellular phone are commercially available. Hence, one brand of cellular phone will definitely be eliminated from the market if it cannot satisfy the increasing needs of vast consumers. Thus, whether the cellular phones produced in the future can provide a more convenient and effective feature will be an indicator to decide whether the manufacturing technology owned by one manufacturer of cellular phone is more advanced than other manufacturers of cellular phone.

For example, chat is added in the features of a cellular phone by the manufacturer for meeting personal needs. The chat, when selected and executed, can enable a user to input data containing characters by operating keypad of a cellular phone. The data containing characters is then sent to at least one second cellular phone. Alternatively, the cellular phone user can receive data containing characters from at least one second cellular phone. In brief, the cellular phone not only can be used for communicating by means of voice or messages but also can be used for communicating by means of vivid text and icons, thereby totally fulfilling personal needs.

Moreover, Internet Chat or any of other real time communication software has made progress from communicating monotonous text in the past to communicate by means of files, sound, and pictures recently. Further, multimedia is the goal of current communication development. For attracting more people, a number of icons are appeared along with the typical text. Each of these icons has a specific meaning. This makes the Internet Chat or the real time communication software more interesting while chatting. For example, most people know that :-) represents smiling face in which :-) consists of three characters. In editing a file by executing certain real time communication software, a corresponding icon (e.g., smiling face) will appear when three characters (e.g., :-)) are continuously typed (see corresponding icon of the characters (:-)) in FIG. 2). Also, a corresponding icon (e.g., cake) will appear when three characters (e.g., \hat{ }) are continuously typed (see corresponding icon of the character (\hat{ }) in FIG. 2). However, only the typed characters (e.g., a combination of two or three characters) rather than the desired icon will appear on a display of the prior cellular phone when such characters are received. This is unsightly. Further, this can significantly lower fun while chatting. Hence, a need for improvement exists.

### SUMMARY OF THE INVENTION

A primary object of the present invention is to provide a method of converting data containing characters into a corresponding icon on a portable platform. The method comprises the steps of receiving data containing characters by the platform, finding a character group from the data containing characters for representing an icon according to a predetermined format, distinguishing the character group from general characters in the data containing characters, finding an icon corresponding to the character group and the general characters, and showing the icon on a display of the platform. By utilizing the present invention, the above drawback of the prior art can be overcome. The drawback is that only the typed characters rather than the desired icon will appear on a display of the prior platform when such characters are received.

The above and other objects, features and advantages of the present invention will become apparent from the following detailed description taken with the accompanying drawings.

### BRIEF DESCRIPTION OF THE DRAWINGS

FIG. 1 is a block diagram of a portable platform according to the invention;

FIG. 2 is a table of an icon database according to the invention;

FIG. 3 is another table of the icon database according to the invention;

FIG. 4 is a flow chart showing a sequence of method steps performed by the platform of FIG. 1 for receiving data containing characters; and

FIG. 5 is a flow chart showing a sequence of method steps performed by the platform of FIG. 1 for sending data containing characters.

### DETAILED DESCRIPTION OF THE PREFERRED EMBODIMENTS

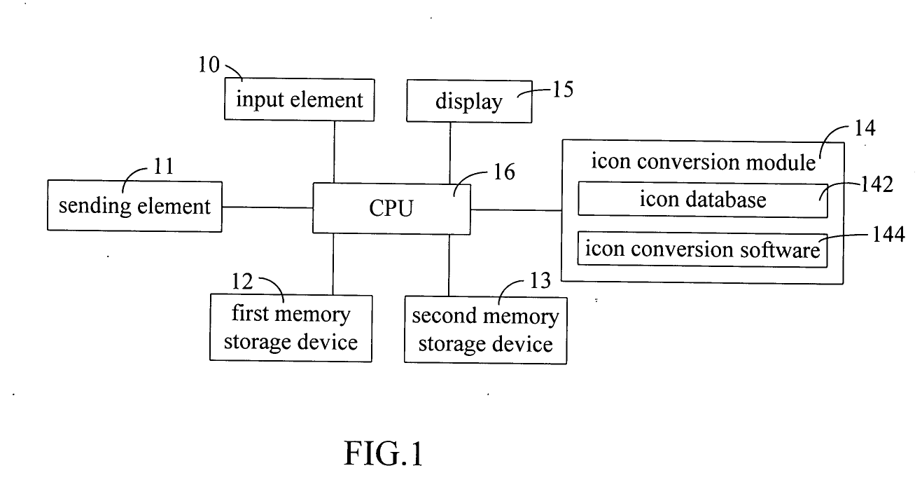

Referring to FIGS. 1 to 5, a method of converting data containing characters into a corresponding icon on a portable platform in accordance with the invention is illustrated. The method comprises the steps of receiving data containing characters by the platform, finding a character group from the data containing characters for representing an icon according to a predetermined format by an icon conversion module 14, distinguishing the character group from general characters in the data containing characters, finding an icon corresponding to the character group and the general characters by the platform, and showing the icon on a display 15 of the platform. In such a manner, the platform is capable of showing the monotonously typed character group as an icon.

Also, a character group in the data containing characters for representing an icon in the Internet Chat is different from that in the real time communication software (e.g., ICQ, MSN, or Yahoo Messenger). This is the key for a typical portable platform to communicate icons with the Internet Chat or the real time communication software. Advantageously, by utilizing the invention it is possible of analyzing data containing characters in advance, finding different character groups and general characters in the data containing characters, and finding a corresponding icon based on the found character group.

In response to receiving data containing characters, the platform will analyze the received data containing characters and find a corresponding icon therefrom. Next, the icon, the same as that shown on the Internet Chat or the real time communication software, will be shown on the platform. Likewise, in a case that the platform sends data containing characters to the Internet Chat or the real time communication software, a corresponding character group will be converted from the data containing characters by the Internet Chat or the real time communication software. In other words, the Internet Chat or the real time communication software is capable of converting the received data containing characters into a corresponding icon. Thus, a complete sending and reception is done.

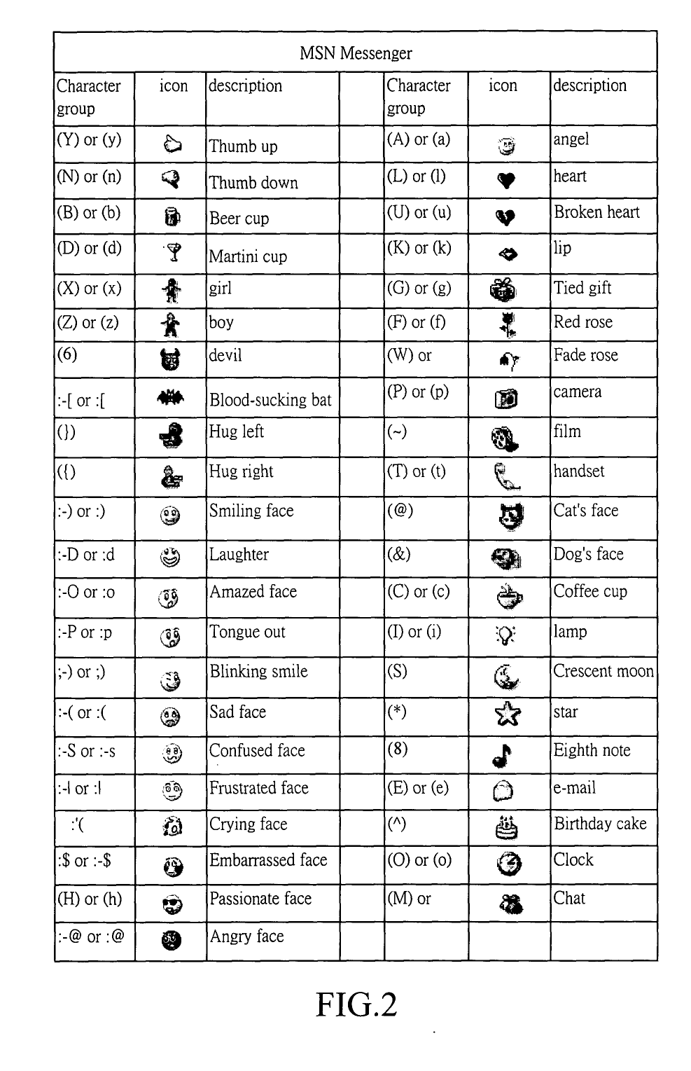

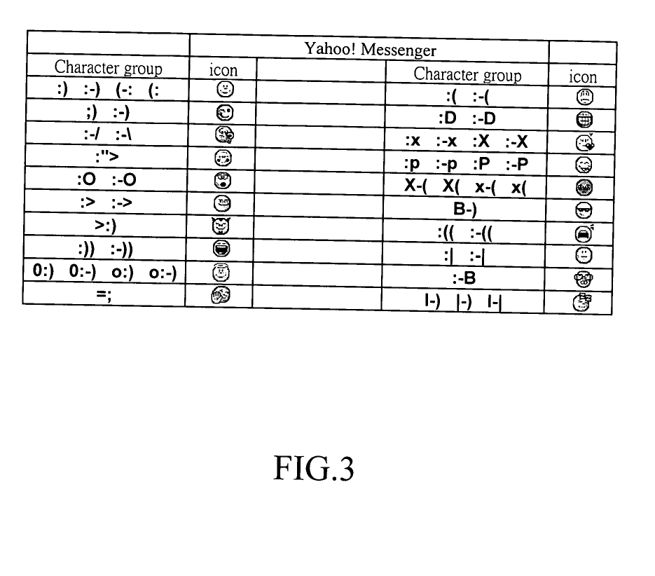

Referring to FIG. 1, in a preferred embodiment of the invention the platform further comprises an input element 10, a sending element 11, a first memory storage device 12, and a second memory storage device 13. The icon conversion module 14 comprises an icon database 142 and an icon conversion software 144. The input element 10 is adapted to input data into the platform. The sending element 11 is adapted to receive or send data containing characters. The first memory storage device 12 is adapted to store the received data containing characters. The second memory storage device 13 is adapted to store data containing characters to be sent. The icon database 142 contains a plurality of character groups and a plurality of icons corresponding the character groups (see FIGS. 2 and 3). The icon conversion software 144 is adapted to analyze and find a character group contained in the data containing characters and convert the same into a corresponding icon.

In a case that the sending element 11 of the platform receives data containing characters from an external source the received data containing characters will be stored in the first memory storage device 12. Next, the icon conversion software 144 analyzes data containing characters in the first memory storage device 12 prior to comparing all characters of the character group in the data containing characters with respective character groups of the icon database 142 sequentially. The icon conversion software 144 will convert the character group in the data containing characters into a corresponding icon if the character group in the data containing characters is matched with the character group of the icon database 142. The corresponding icon is then shown on the display 15. Likewise, in another case that the platform sends data containing characters the data containing characters will be stored in the second memory storage device 13 by means of the input element 10. Next, the icon conversion software 144 analyzes the data containing characters in the second memory storage device 13, converts the character group in the data containing characters into a corresponding icon based on the matched character group in the icon database 142, and shows the icon on the display 15.

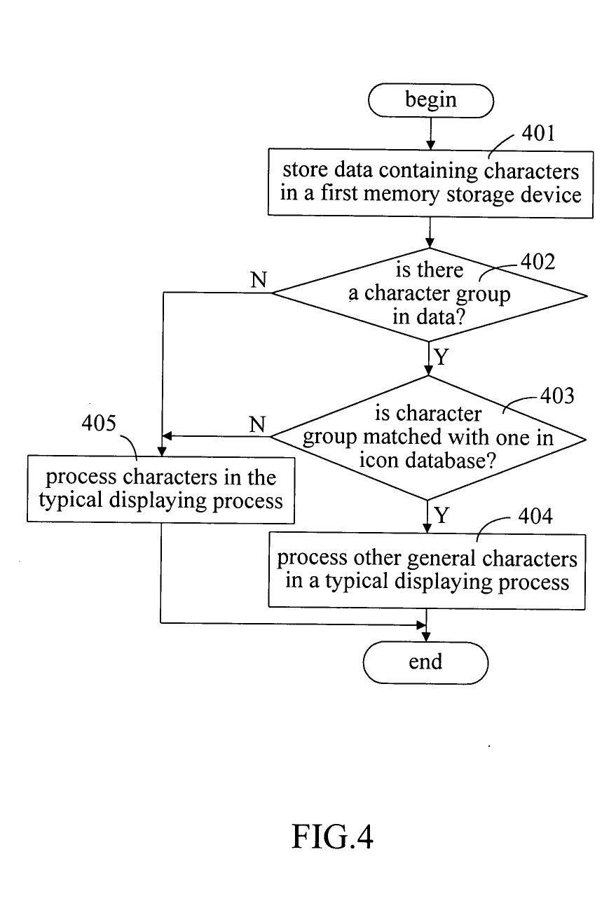

Referring to FIG. 4 in conjunction with FIG. 1, in another preferred embodiment of the invention in response to receiving data containing characters from the Internet Chat or the real time communication software by the sending element 11 of the platform a CPU (central processing unit) 16 of the platform will perform the following steps in a process:

In step 401, first store data containing characters in the first memory storage device 12.

In step 402, the icon conversion software 144 determines whether there is a character group in the data containing characters. If yes, the process goes to step 403. Otherwise, the process jumps to step 405.

In step 403, determines whether the character group is matched with a character group in the icon database 142. If yes, the process goes to step 404. Otherwise, the process jumps to step 405.

In step 404, find an icon corresponding the matched character group and show the icon on the display 15 while processing other general characters in a typical displaying process. The process ends normally.

In step 405, process characters in the typical displaying process.

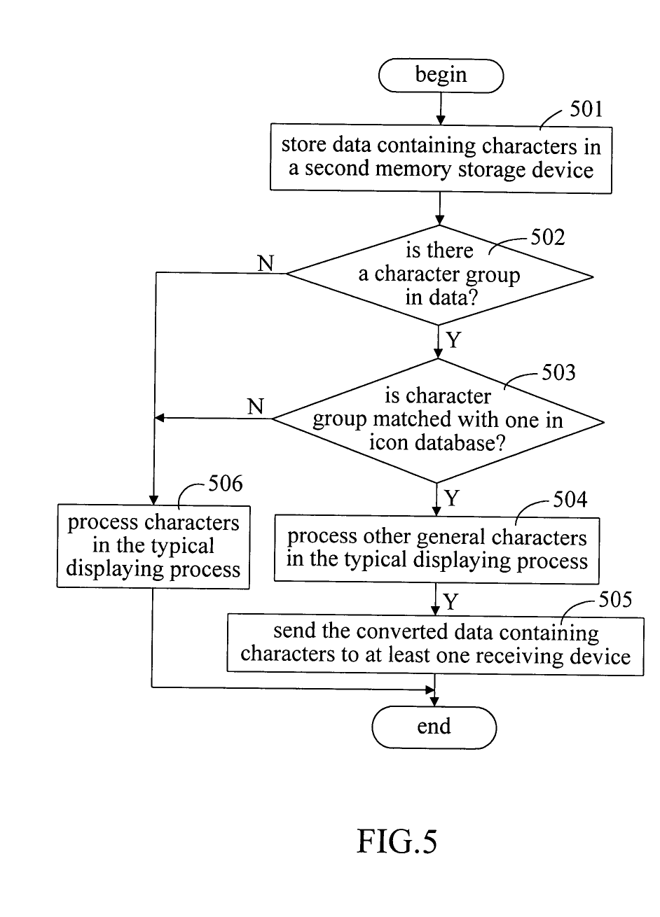

Referring to FIG. 5 in conjunction with FIG. 1, in response to sending data containing characters from the sending element 11 to the Internet Chat or the real time communication software the CPU 16 of the platform will perform the following steps in a process:

In step 501, first store data containing characters to be sent in the second memory storage device 13.

In step 502, the icon conversion software 144 determines whether there is a character group in the data containing characters. If yes, the process goes to step 503. Otherwise, the process jumps to step 506.

In step 503, determines whether the character group is matched with a character group in the icon database 142. If yes, the process goes to step 504. Otherwise, the process jumps to step 506.

In step 504, find an icon corresponding the matched character group and show the icon on the display 15 while processing other general characters in a typical displaying process.

In step 505, send the converted data containing characters to at least one receiving device in response to receiving a sending command from the input element 10. The process ends normally.

In step 506, process characters in the typical sending process. The process ends normally.

An embodiment will be described in detail below for fully understanding the invention. As shown in FIG. 1, in response to receiving data containing characters (e.g., “happy birthday to you, send you a \hat{ }”) by the sending element 11 of the platform storing the data containing characters in the first memory storage device 12. Next, the icon conversion software 144 determines whether there is a character group in the data containing characters stored in the first memory storage device 12. If A is found to be the character group, the character group will be compared with icons in the icon database for finding a corresponding icon of birthday cake (see corresponding icon of the character (\hat{ }):-) in FIG. 2). Next, convert the character group into a corresponding icon and show the icon on the display 15.

Likewise, in a case that the sending element 11 of the platform desires to reply the received data containing characters by sending an icon of “thank you, smiling face” (see corresponding icon of the character (:-)) in FIG. 2) store data containing characters containing “thank you, smiling face” in the second memory storage device 13. Next, the icon conversion software 144 finds a corresponding icon from the icon database and converts the icon into one matched with an icon in the icon database 142. As a result, a correct meaning will be expressed by the Internet Chat or the real time communication software.

While the invention has been described by means of specific embodiments, numerous modifications and variations could be made thereto by those skilled in the art without departing from the scope and spirit of the invention set forth in the claims.

1. A method of converting data containing characters into a corresponding icon on a portable platform, comprising the steps of:
receiving data containing characters by the platform;
finding a character group from the data containing characters for representing an icon according to a predetermined format by an icon conversion module of the platform;
distinguishing the character group from general characters in the data containing characters;
finding an icon corresponding to the character group and the general characters by the platform; and
showing the icon on a display of the platform.

2. The method of claim 1, wherein the platform further comprises an input element, a sending element, first memory storage means, and second memory storage means, the icon conversion module includes an icon database and an icon conversion software, the input element is adapted to input data into the platform, the sending element is adapted to receive or send data containing characters, the first memory storage means is adapted to store the received data containing characters, the second memory storage means is adapted to store the data containing characters to be sent, the icon database contains a plurality of character groups and a plurality of icons corresponding the character groups, and the icon conversion software is adapted to analyze and find a character group contained in the data containing characters and convert the same into a corresponding icon.

3. The method of claim 2, wherein in response to receiving data containing characters from an external source by the sending element of the platform, the received data containing characters is stored in the first memory storage means, the icon conversion software analyzes the data containing characters in the first memory storage means, all characters of the character group in the data containing characters are compared with respective character groups of the icon database sequentially, the icon conversion software converts the character group in the data containing characters into a corresponding icon if the character group in the data containing characters is matched with the character group of the icon database, and show the corresponding icon n the display.

4. The method of claim 2, wherein prior to sending data containing characters from the platform the data containing characters is stored in the second memory storage means by means of the input element, the icon conversion software analyzes the data containing characters in the second memory storage means, converts the character group in the data containing characters into a corresponding icon based on the matched character group in the icon database, and shows the corresponding icon on the display.

5. The method of claim 3, wherein in response to receiving data containing characters by the sending element of the platform a CPU (central processing unit) of the platform performs steps comprising:
storing the data containing characters in the first memory storage means;
causing the icon conversion software to determine whether there is a character group in the data containing characters;
if there is a character group in the data containing characters, determining whether the character group in the data containing characters is matched with a character group in the icon database; and
if the character group in the data containing characters is matched with a character group in the icon database, finding an icon corresponding the matched character group in the icon database, showing the corresponding icon on the display, and processing the general characters in a typical displaying process.

6. The method of claim 5, wherein, if there isn't a character group in the data containing characters, processes the data containing characters in a typical displaying process.

7. The method of claim 5, wherein, if the character group in the data containing characters isn't matched with a character group in the icon database, processes the data containing characters in a typical displaying process.

8. The method of claim 4, wherein in response to sending data containing characters by the sending element of the platform the CPU of the platform performs steps comprising:
storing the data containing characters to be sent in the second memory storage means;
causing the icon conversion software to determine whether there is a character group in the data containing characters;
determining whether the character group in the data containing characters is matched with a character group in the icon database;
if the character group in the data containing characters is matched with a character group in the icon database, finding an icon corresponding the matched character group, showing the corresponding icon on the display, and processing the general characters in a typical displaying process; and
sending the converted data containing characters to at least one receiving means in response to receiving a sending command from the input element.

9. The method of claim 8, wherein, if there isn't a character group in the data containing characters, processes the data containing characters in a typical sending process.

10. The method of claim 8, wherein, if the character group in the data containing characters isn't matched with a character group in the icon database, processes the data containing characters in a typical sending process.
